(19) United States
(12) Patent Application Publication
(10) Pub. No.: US 2011/0146470 A1
(43) Pub. Date: Jun. 23, 2011

(54) Woodworking Machine with Sensing Device

(76) Inventor: Kun-Yen Lin, Taichung City (TW)

(21) Appl. No.: 12/640,079

(22) Filed: Dec. 17, 2009

(51) Int. Cl. B23D 45/06; B27B 5/24; B26D 7/27

(52) U.S. Cl. 83/477.1; 83/477.2; 83/478; 83/522.17

(57) ABSTRACT

A woodworking machine comprises a base including a lateral wall, a coupled wall having an end coupled to the lateral wall and a working surface provided on a top surface of the lateral wall and having a slot and an indicator, with a thing desired to be cut being placed on the working surface; an active adjustment unit inserted through the lateral and coupled walls; a driven adjustment unit inserted through the coupled wall and engaged with the active adjustment unit; a sensing device connected to the driven adjustment unit and able to sense an adjusted displacement distance of the driven adjustment unit and further convert the displacement distance to a signal and transfer the signal to the indicator; an actuating device where the driven adjustment unit is mounted on; and a saw connected to the actuating device and exposing from the slot.

### BACKGROUND OF THE INVENTION

1. Field of the Invention

The present invention relates to a woodworking machine with a sensing device and, more particularly, to a woodworking machine with a sensing device which is able to sense amount of feed of a saw for conversion from the amount of feed of the saw to a value shown by an indicator.

2. Description of the Related Art

Referring to U.S. Pat. No. 6,543,324, it shows a table saw provided having a scale on the upper side thereof adjacent the region of the elongated slot for the circular saw blade. The scale provides an indication of the height of a specified diameter saw blade corresponding to the chordal length of a segment of saw blade protruding through the elongate slot.

However, in order to refer to the scale easily during sawing, the scale must be adjacent to the saw blade. Hence, while a thing desired to be cut is placed on a working surface of the table saw, the scale would be hidden by the thing and user cannot determine the height of the saw blade immediately till removal of the thing from the working surface. Further, it produces a lot of wood flour during sawing, and the wood flour would hide the scale. In the meanwhile, user might push the wood flour aside at will to expose the scale outside, and it's easy to get hurt by the saw blade.

### SUMMARY OF THE INVENTION

Accordingly, the object is achieved by providing a woodworking machine with a sensing device which has an indicator, the woodworking machine comprising a base, an active adjustment unit, a driven adjustment unit, an actuating device and a saw.

The sensing device is able to convert an amount of feed of the saw to a precise value to be read on the indicator.

The sensing device further includes a cover to prevent wood flour of a thing desired to be cut or dust from covering on the driven adjustment unit and the sensing device.

The sensing device is installed to the driven adjustment unit directly to avoid the measurement errors certainly.

Other advantages and features of the present invention will become apparent from the following descriptions referring to the drawings.

### BRIEF DESCRIPTION OF THE DRAWINGS

The present invention will be described through detailed illustration of three embodiments referring to the drawings.

FIG. 1 is a perspective view of a woodworking machine with a sensing device according to the preferred embodiment of the present invention.

FIG. 2 is a partial, perspective view of the woodworking machine as shown in FIG. 1.

FIG. 3 is a partial, exploded view of the woodworking machine as shown in FIG. 1.

FIG. 4 is another partial, exploded view of the woodworking machine as shown in FIG. 1.

FIG. 5 is a cross-sectional view of the woodworking machine as shown in FIG. 1.

FIG. 6 is a partial, enlarged view of the woodworking machine as shown in FIG. 5, illustrating that the active adjustment unit is engaged with the driven adjustment unit.

FIG. 7 is a partial, enlarged view of the woodworking machine as shown in FIG. 5, illustrating the sensing device.

FIG. 8 is a cross-sectional view similar to FIG. 5, illustrating longitudinal movement of the saw by operating the rotary element.

### DETAILED DESCRIPTION OF THE PREFERRED EMBODIMENT

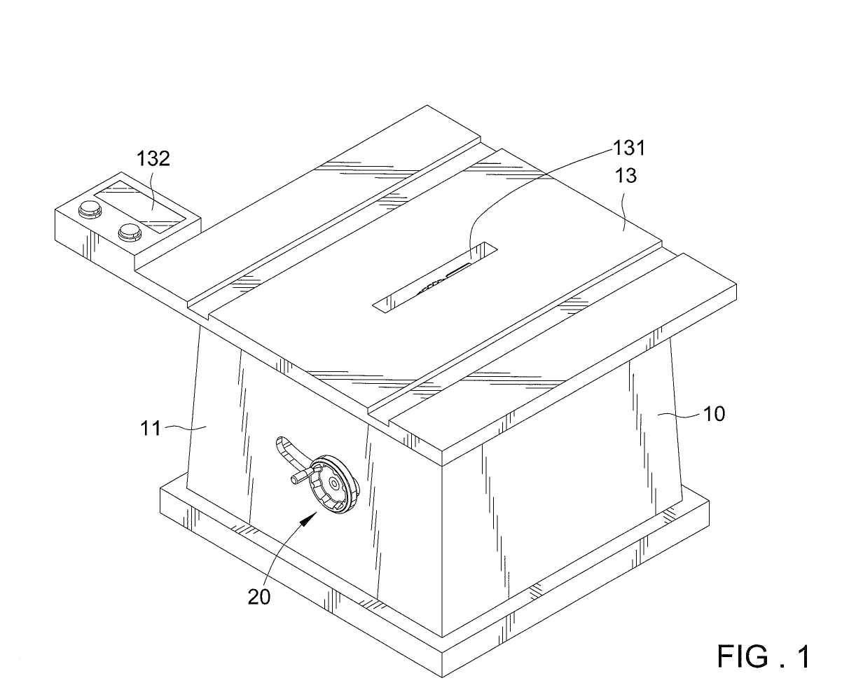

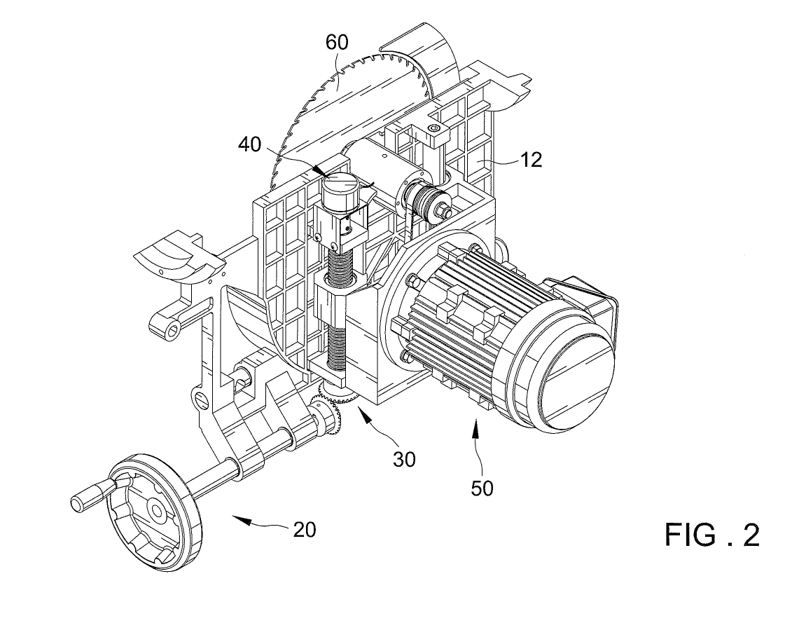

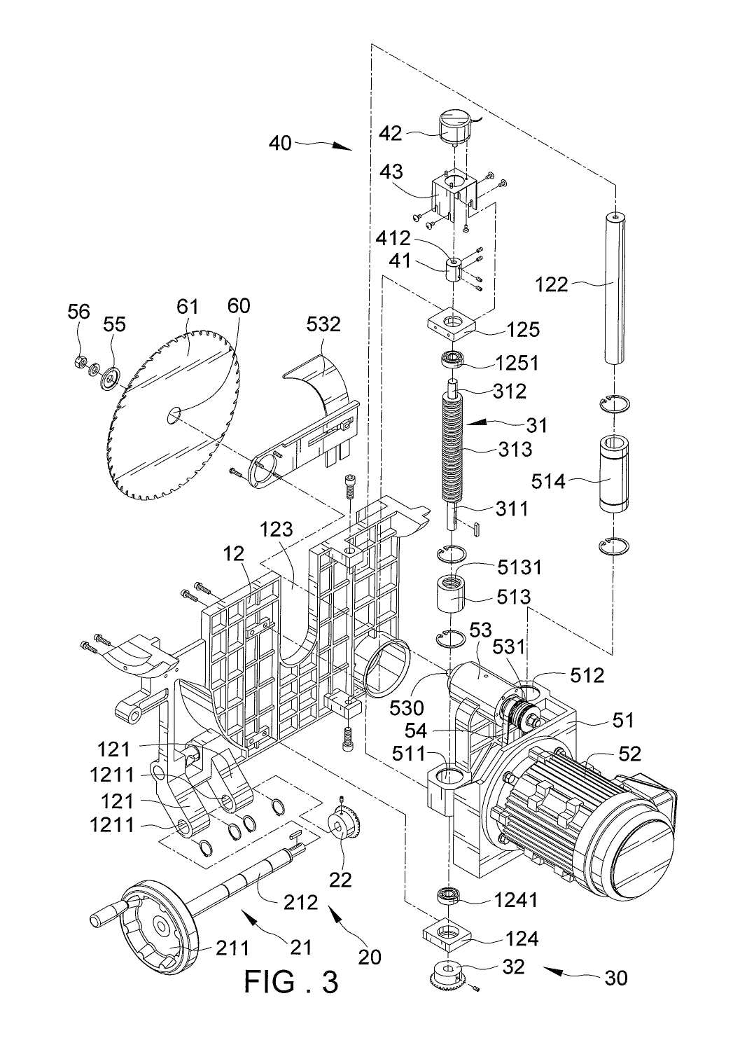

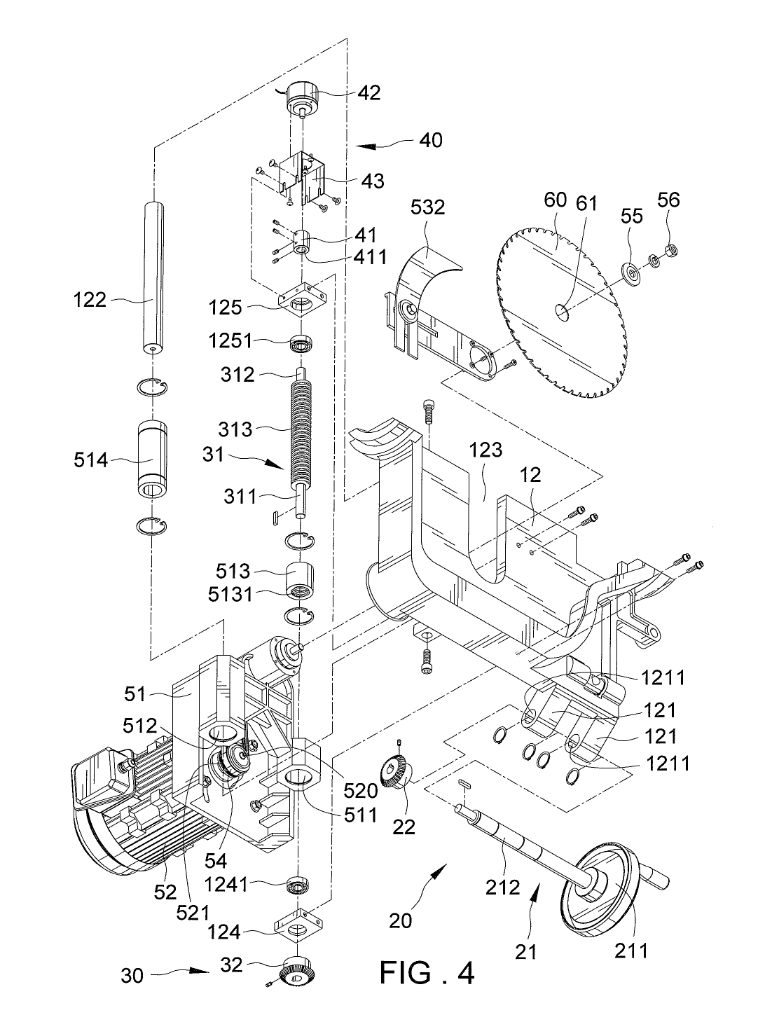

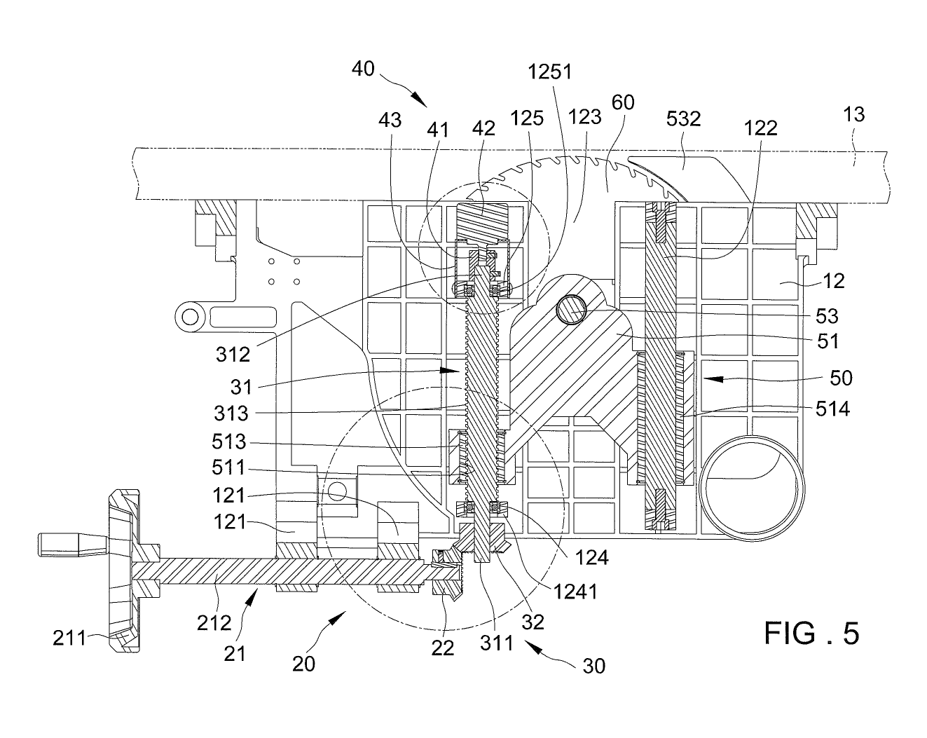

Referring to FIGS. 1 through 5, they show a woodworking machine which includes a base 10, an active adjustment unit 20, a driven adjustment unit 30, a sensing device 40, an actuating device 50 and a saw 60.

The base 10 includes a lateral wall 11, a coupled wall 12 and a working surface 13, where a thing desired to be cut is placed on, provided on the top surface of the lateral wall 11 and having a slot 131 inserted by the saw 60 and an indicator 132 showing sensor data which is determined by the sensing device 40. The active adjustment unit 20 is inserted through the lateral and coupled walls 11 and 12. The driven adjustment unit 30 is inserted though the coupled wall 12 and engaged with the active adjustment unit 20. The sensing device 40 is able to sense and measure what's a displacement distance of the driven adjustment unit 30 by adjusting, and further convert the measured displacement distance to a signal to transfer to the indicator 132. The driven adjustment unit 30 is coupled to the actuating device 50 and drives the actuating device 50 to move longitudinally with respect to the working surface 13. The saw 60, which is connected to the actuating device 50 and protrudes from the slot 131, is able to move longitudinally with respect to the actuating device 50. The sensing device 40 is installed to the driven adjustment unit 30 directly to avoid the measurement errors certainly.

The coupled wall 12 has two lugs 121 formed from the bottom thereof and spaced from each other. An aperture 1211 is formed on each lug 121. A limited rod 122 is provided at a side of the coupled wall 12 and the two lugs 121 is provided at another side of the coupled wall 12 which is sandwiched between the limited rod 122 and the two lugs 121. An upper end and a lower end of the coupled wall 12 are connected to each other via the limited rod 122. A receptacle 123, a first limited element 124 and a second limited element 125 are formed on the coupled wall 12 between the lugs 121 and the limited rod 122. The receptacle 123 is adjacent to the limited rod 122; the first limited element 124 is adjacent to the lugs 121; the first and second limited elements 124 and 125 are respectively provided at the upper and lower ends of the coupled wall 12. Bearings 1241 and 1251 are respectively provided in the first and second limited elements 124 and 125.

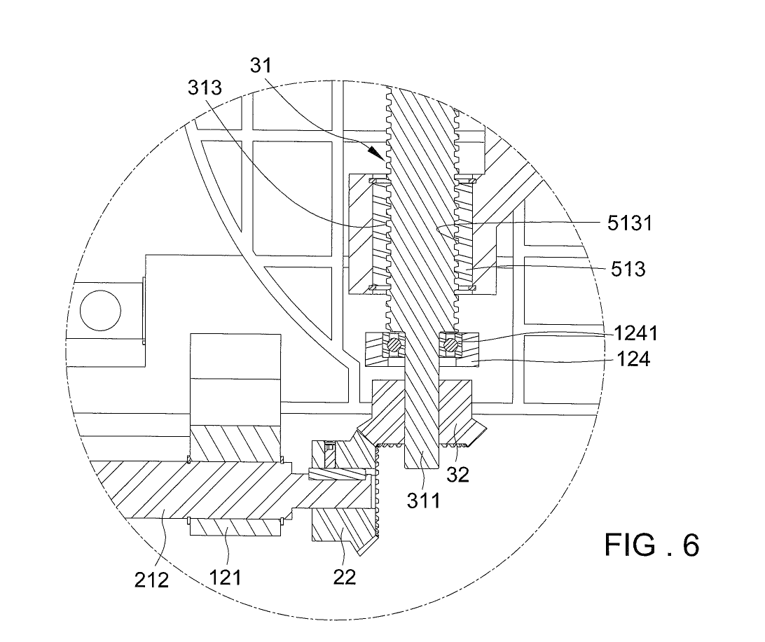

Further referring to FIG. 6, the active adjustment unit 20 includes a rotary element 21 and a first helical gear 22. A hand wheel 211 is formed at an end of the rotary element 21 and exposes from the lateral wall 11 of the base 10. A rotary portion 212 is provided at the other end of the rotary element 21 opposite to the hand wheel 211 and inserted through the apertures 1211 and coupled to the first helical gear 22. Therefore, the first helical gear 22 can be driven by rotation of the hand wheel 211.

The driven adjustment unit 30 includes a bolt 31 and a second helical gear 32. A first axial portion 311 and a second axial portion 312 are respectively formed on two ends of the bolt 31, and a threaded portion 313 are formed on the outer periphery of the bolt 31 between the first and second axial portions 311 and 312. The first and second axial portions 311 and 312 are respectively inserted into the bearings 1241 and 1251 of the first and second limited elements 124 and 125. The first axial portion 311 is coupled to the second helical gear 32 which is engaged with the first helical gear 22. The driven adjustment unit 30 intersects with the active adjustment unit 20 vertically.

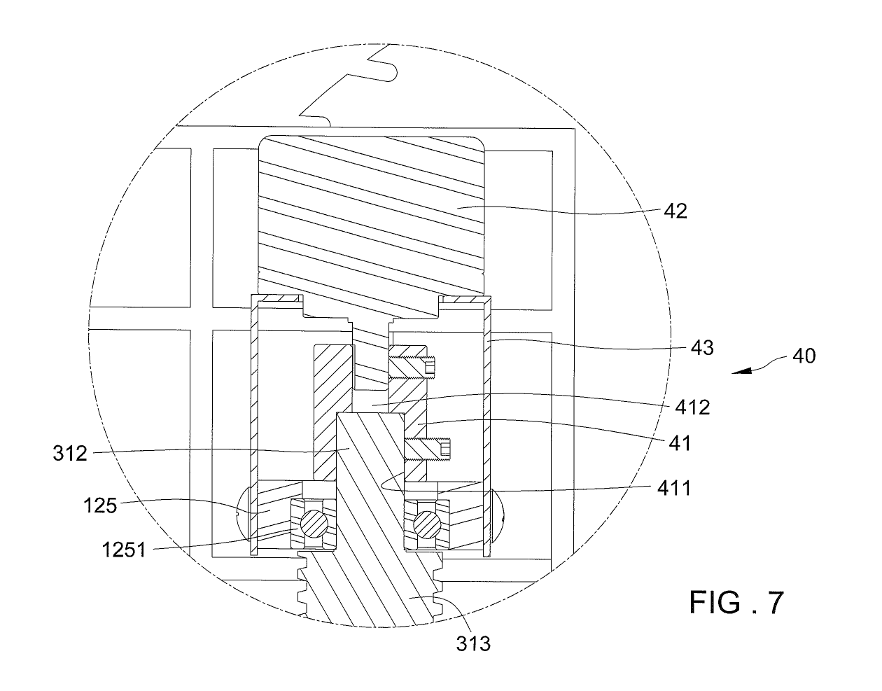

Referring to FIG. 7, the sensing device 40 includes a connected element 41, a sensor 42 and a cover 43 and adapted to sense an arc of rotation of the bolt 31 and further convert to a displacement distance of the saw 60. A first connected hole 411 and a second connected hole 412 are axially formed on the connected element 41 and the first connected hole 411 is connected to the second axial portion 312. A sensing axle 421 protrudes from an end of the sensor 42 toward the connected element 41 and is connected to the second connected hole 412. The connected element 41 is driven to rotate by the second axial portion 312 of the bolt 31 and drives the sensing axle 421 of the sensor 42 so that the sensor 42 can convert an arc of rotation of the sensing axle 421 to a longitudinal displacement distance of the saw 60 and the indicator 132 would show a value of the longitudinal displacement distance of the saw 60. The cover 43 is fixed to the second limited element 125 and covers on the connected element 41 to prevent wood flour of the thing desired to be cut or dust from covering on the second axial portion 312 and the sensing axle 421.

The actuating device 50 includes a main body 51, a motor 52, a main axle 53 and a belt 54. A side of the main body 51 forms with a first receiving hole 511 and a second receiving hole 512. A threaded sleeve 513 is provided in the first receiving hole 511 and forms with a threaded hole 5131. The threaded portion 313 of the bolt 31 is engaged with the threaded hole 5131 in a screw manner. A bushing 514 is provided in the second receiving hole 512 and mounted on the limited rod 122. The main body 51 of the actuating device 50 is able to be adjusted via the driven adjustment unit 30 and moves with respect to the limited rod 122 longitudinally. The motor 52 is fixed to the main body 51 and includes an axle center 521 which is coupled to an active belt pulley 521. The main axle 53 is located on the top of the main body 51 and includes an axle center 530 which is coupled to a driven belt pulley 531. The belt 54 is wound on the active and driven belt pulleys 521 and 531. The active belt pulley 521 of the motor 52 drives the driven belt pulley 531 of the main axle 53 to rotate. In other words, the main axle 53 is driven by the motor 52 via the belt 54. A splash guard 532 is fixed to a distal end of the main axle 53.

The saw 60 forms with a through-hole 61 on the center thereof. The axle center 530 of the main axle 53 is inserted through the through-hole 61 of the saw 60. A fixture element 56 is engaged with the distal end of the axle center 530 to fix the saw 60 to the main axle 53 and a distance piece 55 is provided between the fixture element 56 and the saw 60 for a firm engagement of the saw 60 and the fixture element 56. The saw 60 is able to move longitudinally along the receptacle 123 with the actuating device 50. An end of the splash guard 532 is fixed to the distal end of the main axle 53 and another end of the splash guard 532 is partially and annularly provided on the outer periphery of the saw 60.

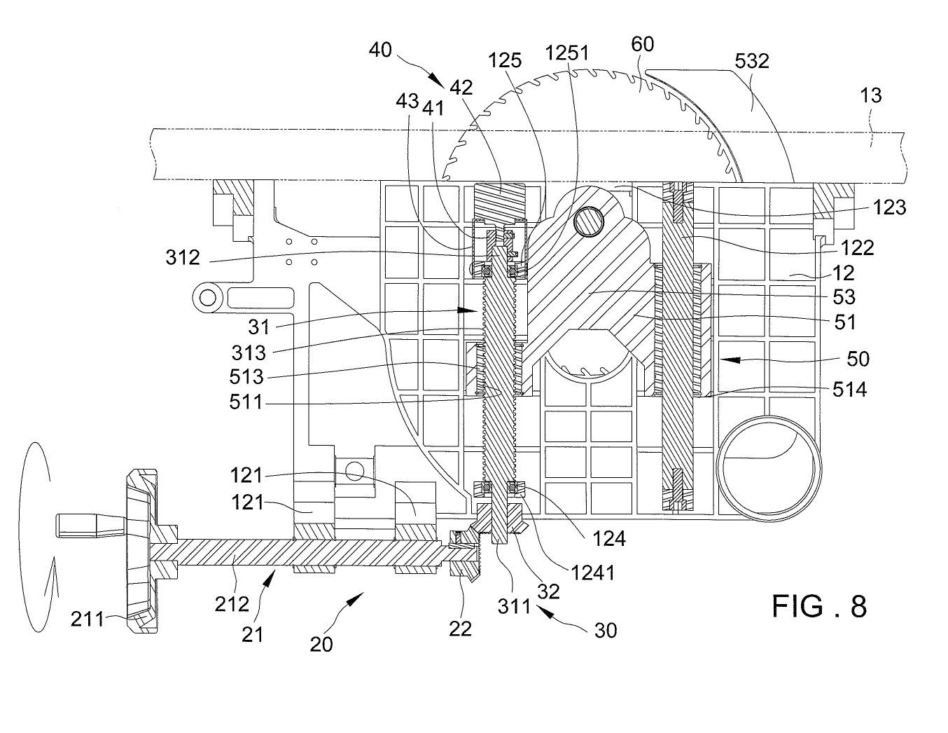

Referring to FIG. 8, while users rotate the hand wheel 211 of the active adjustment unit 20 and the rotary portion 212 is driven to rotate, the first helical gear 22 drives the second helical gear 32 to rotate and the second helical gear 32 drives the bolt 31 to rotate. The bearings 1241 and 1251 provide the bolt 31 to rotate with respect to the first and second limited elements 124 and 125 in a smooth manner. Moreover, the bolt 31 rotates in the threaded sleeve 513 to drive the actuating device 50 to move longitudinally and the bushing 514 of the actuating device 50 is able to move longitudinally along the limited rod 122 of the coupled wall 12. The bolt 313 and the limited rod 122 are respectively provided at two sides of the actuating device 50 and provide to the actuating device 50 to move longitudinally stably and not to sway. The main axle 53 of the actuating device 50 drives the saw 60 to rotate and move longitudinally with the actuating device 50. The sensor 42 of the sensing device 40 is able to convert an arc of rotation of the bolt 31 to a longitudinal displacement distance of the saw 60 and transfer a value of the displacement distance to the indicator 132. Hence, it can convert an amount of feed of the saw 60 to a precise value to be read on the indicator 132.

While several embodiments of the invention have been shown and described, it will be apparent to those skilled in the art that modifications may be made therein without departing from the scope and spirit of the present invention.

What is claimed is:

1. A woodworking machine comprising:
a base including a lateral wall, a coupled wall having an end coupled to the lateral wall and a working surface provided on a top surface of the lateral wall and having a slot and an indicator, with a thing desired to be cut being placed on the working surface;
an active adjustment unit inserted through the lateral and coupled walls;
a driven adjustment unit inserted through the coupled wall and engaged with the active adjustment unit;
a sensing device connected to the driven adjustment unit and able to sense an adjusted displacement distance of the driven adjustment unit and further convert the displacement distance to a signal and transfer the signal to the indicator;
an actuating device where the driven adjustment unit is mounted on and able to move with the driven adjustment unit longitudinally; and
a saw connected to the actuating device and exposing from the slot, with the saw moving with the actuating device longitudinally.

2. The woodworking machine as claimed in claim 1 wherein the driven adjustment unit includes a bolt, with the sensing device sensing an arc of rotation of the bolt and converting to a displacement distance of the saw.

3. The woodworking machine as claimed in claim 2 further comprising a threaded portion provided between the two ends of the bolt; wherein the actuating device includes a main body having a threaded hole formed on a side thereof, with the threaded portion of the bolt engaged with the threaded hole of the main body in a screw manner.

4. The woodworking machine as claimed in claim 3 wherein the active adjustment unit includes a rotary element and a first helical gear coupled to the rotary element; wherein the driven adjustment unit includes a second helical gear; wherein the bolt includes a first axial portion formed on an end thereof, with the first axial portion coupled to the second helical gear engaged with the first helical gear.

5. The woodworking machine as claimed in claim 4 further comprising a second axial portion formed on another end of the bolt opposite to the first axial portion; wherein the sensing device includes a connected element forming with a first connected hole and a second connected hole axially and a sensor having a sensing axle, with the first connected hole connected to the second axial portion, with the second connected hole connected to the sensing axle, and with the sensing device sensing an arc of rotation of the sensing axle and converting to a longitudinal displacement distance of the saw.

6. The woodworking machine as claimed in claim 5 further comprising a cover; wherein the coupled wall includes a first limited element inserted by the bolt, with the cover fixed to the first limited element and covering the connected element of the sensing device.

7. The woodworking machine as claimed in claim 3 further comprising at least one lug formed on the bottom of the coupled wall and having an aperture, with the active adjustment unit inserted through the aperture.

8. The woodworking machine as claimed in claim 7 wherein the coupled wall is sandwiched by the at least one lug and a limited rod which is connected to an upper end and a lower end of the coupled wall to each other.

9. The woodworking machine as claimed in claim 8 wherein the main body of the actuating device forms with a first receiving hole and a second receiving hole, with a threaded sleeve provided in the first receiving hole and having a threaded hole, with the bolt engaged with the threaded hole, with a bushing provided in the second receiving hole mounted on the limited rod, and with the main body of the actuating device able to be adjusted via the driven adjustment unit and moving with respect to the limited rod longitudinally.

10. The woodworking machine as claimed in claim 9 further comprising a receptacle formed between the at least one lug and the limited rod, with the saw able to move along the receptacle with the actuating device.

11. The woodworking machine as claimed in claim 9 further comprising a first limited element and a second limited element provided between the at least one lug and the limited rod, with the first and second limited elements being in the same axial position and respectively provided at the upper and lower ends of the coupled wall.

12. The woodworking machine as claimed in claim 11 further comprising bearings respectively provided in the first and second limited elements, with the bolt including a first axial portion and a second axial portion formed on two ends thereof and respectively inserted though the bearings.

13. The woodworking machine as claimed in claim 8 wherein the actuating device includes a motor fixed on the main body thereof, a main axle and a belt, with the main axle being driven by the motor via the belt, and with the saw fixed to the main axle.

14. The woodworking machine as claimed in claim 13 further comprising a splash guard fixed to the main axle and partially and annularly provided on the outer periphery of the saw.
